(19) United States
(12) Patent Application Publication
(10) Pub. No.: US 2024/0273428 A1
(43) Pub. Date: Aug. 15, 2024

(54) SYSTEM AND METHOD OF A MOBILE SERVICE REQUEST APPLICATION

(71) Applicant: Matthew Lane, Land O' Lakes, FL (US)

(72) Inventor: Matthew Lane, Land O' Lakes, FL (US)

(21) Appl. No.: 18/586,494

(22) Filed: Feb. 25, 2024

Related U.S. Application Data
(63) Continuation-in-part of application No. 17/643,018, filed on Dec. 7, 2021, now abandoned.

(51) Int. Cl. G06Q 10/0631

(52) U.S. Cl. CPC G06Q 10/063112; G06Q 10/06314

(57) ABSTRACT

A system of a mobile service request application and algorithm is provided comprising a computer and an application comprising an algorithm. The system receives a service request from a customer device comprising at least a location of a service need. The system also determines a service area associated with the location. The system also identifies locations of technician devices associated with technicians presently located in the service area, the technicians identified as qualified to address the service need. The system ranks the technicians by parameters including distance to the location of the service need and technician queue size by pending service calls. The system also assigns weights to each parameter for each technician. Based on at least on the assigned weights, the system also generates a final ranking for the technicians. Based at least on the ranking, the system also dispatches a first technician to the location of service need.

### CROSS-REFERENCE TO RELATED APPLICATIONS

The present non-provisional patent application is a continuation-in-part application of U.S. patent application Ser. No. 17/643,018 filed Dec. 7, 2021 which claimed the benefit of priority of U.S. provisional application No. 63/198,776 filed Nov. 12, 2020 and claimed the benefit of U.S. provisional application No. 63/199,102 filed Dec. 7, 2020, the contents of both are herein incorporated by reference.

### FIELD OF THE DISCLOSURE

The present disclosure is in the field of delivery of customer service at remote locations. More particularly, the present disclosure provides systems and methods of a customer requesting service at a remote location and being matched with a field technician who is best suited to handle to service call with tools provided to communicate and monitor technician travel activity.

### BACKGROUND OF THE INVENTION

The present invention relates to mobile computer applications, and more particularly, to a mobile application used to streamline managed service provider and customer processes.

When a service request is placed, it has normally been done by phone or email with live dispatch personnel. The ability of companies to communicate and respond to service requests from their customers is thus limited by their turnaround time when handling live phone calls, email, or chat. Furthermore, subsequent a request a delay or miscommunication of expectations between the customer and servicing company may occur and, as a result, changes to (or even a status check request of) the initial request would also be routed through the same bottleneck associated with handling live phone calls, email, or chat. Currently, options do not exist for customers requesting service to place a request for service from the convenience of their mobile device, at anytime from anywhere While technology exists for industries such as hospitality and transportation, there are no options for consumer service requests.

A need exists for a mobile application which enables a user who is a customer of a service provider to request a service from their mobile computing device's user interface, which is also configured to receive live updates about the service request as well as see an assigned technician GPS location when the technician is on the way to the user location to address the request.

The present invention avoids bottlenecks associated with conventional means of communication by enabling the user interface of a computing device to become a one-stop-shop for placing a request for service, tracking the status of said service request, or making modification to the service request. A user may initiate a request for service directly from the mobile application, and request and receive live real-time updates as the service request is dispatched and resolved. The data of the service request and service request may also be also logged under a user account associated with the user, where the user may access and view the user service history, as well as make changes to the service request.

The application, system and method of the present invention provides an unprecedented improvement over existing service call fulfillment systems, thereby remedying problems caused by service provider communication and response limited to and by live phone calls, email, or chat and the attendant delays in updates to and changes by the customer.

In one aspect of the present invention, service provider system, including the following: a plurality of service provider computing devices connected as a network of computing devices, wherein each respective service provider computing device is configured to transmit a GPS signal and a service provider identifier thereof; each service provider computing device has a provider communication interface; a user computing device having a user communication interface in receipt of a site location and a service request comprising service request data; and a server coupling the plurality of service provider computing devices and the user computing device so that one of the plurality of service provider computing devices is assigned to the service request based in part on the site location and the service request data, wherein the GPS signal of the assigned service provider computing device is represented on a map on the user communication interface.

In another aspect of the present invention, the above-mentioned service provider system includes wherein the server is configured to represent on the user communication interface an estimated time of arrival of the GPS signal at the site location, wherein the server is configured to represent on the user communication interface the service provider identifier, wherein the service provider identifier includes a name and a contact information, wherein the service provider identifier includes a name and a contact information, wherein the service request data comprises a description of a service, wherein the service request data comprises a deadline, and wherein the server is configured to reassign another of the plurality of service provider computing devices based on the description of a service, the deadline, and the GPS signal of the assigned service provider computing device.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention.

FIG. 2 is a schematic view of an exemplary embodiment of the present invention.

FIG. 3 is a schematic view of an exemplary embodiment of the present invention.

FIG. 4 is a schematic view of an exemplary embodiment of the present invention.

FIG. 5 is a schematic view of an exemplary embodiment of the present invention.

FIG. 6 is a block diagram of a system of a mobile service request application according to an embodiment of the present disclosure.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a mobile service request application, system, and method.

The system may include at least one computer with a user interface. The computer may include at least one processing unit coupled to a form of memory. The computer may include, but may not be limited to, a microprocessor, a server, a desktop, laptop, and smart device, such as, a tablet and smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the present disclosure necessarily achieves technological improvements through the specific processes described more in detail below. In addition, the unconventional and unique aspects of these specific automation processes represent a sharp contrast to merely providing a well-known or routine environment for performing a manual or mental task.

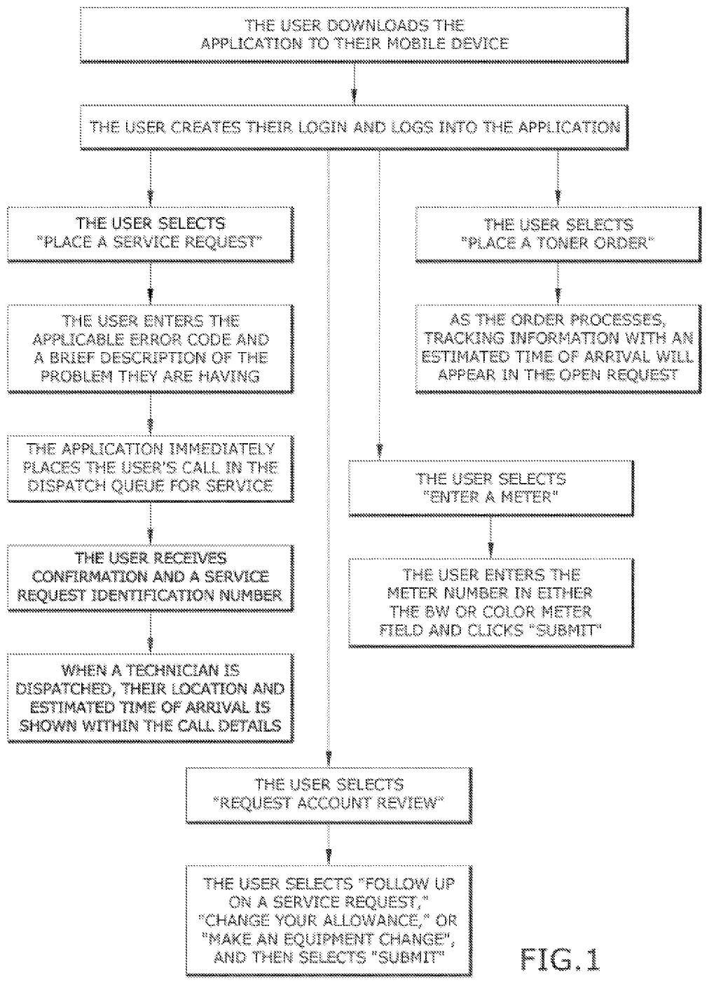

Referring now to the FIGS. 1 through 5, the present invention is directed to a mobile service request application, system, and method. In accordance with an embodiment of the present invention, a mobile application may enable a customer of a service provider to use a mobile computing device to place a service call or request for service. The user may then receive live updates about the service request and view a GPS location of an assigned technician when the technician is on the way to the site location to address to the user's service request. The user may place a request for service directly from the mobile application, and may also receive live, real-time updates as a call is dispatched and resolved. Based on real-time updates, the system or the user may modify the service request or service provider. Service request data may be logged under the user account, where the user may access and view the service history for each service request and associated service request data.

The application, system and method of the present invention solves problems associated with existing service request systems and methods. In prior methods, when a customer service request has been placed, it has been placed by phone or email with live dispatch personnel. A miscommunication of expectations between the customer and the service company may result from these prior methods, and such mistakes would go unnoticed until after the service provider reached the site location. Likewise, changes to an initial service request would be limited by the communication delays of the old model.

The present invention avoids associated problems by enabling the user to place a request for service using the mobile application from the convenience of a mobile computing device at anytime from anywhere.

The mobile application of the present invention allows the user to place a request for service directly from the user mobile phone or mobile device. Once the request has been successfully sent, real time data/updates may then be provided to the user directly from the application, including status updates, estimated time of arrival, real time geographic location of the assigned technician, name and contact information of the assigned technician, and other data relevant to the user account and service request. This data may also be logged under the user account, where the user may access and view the user service history.

Referring now to FIG. 1, in accordance with an exemplary embodiment of the present invention, the application, system, and method may include one or more of the following elements, components, steps, and combinations thereof.

1. A user may download the software application on a computing device 10.

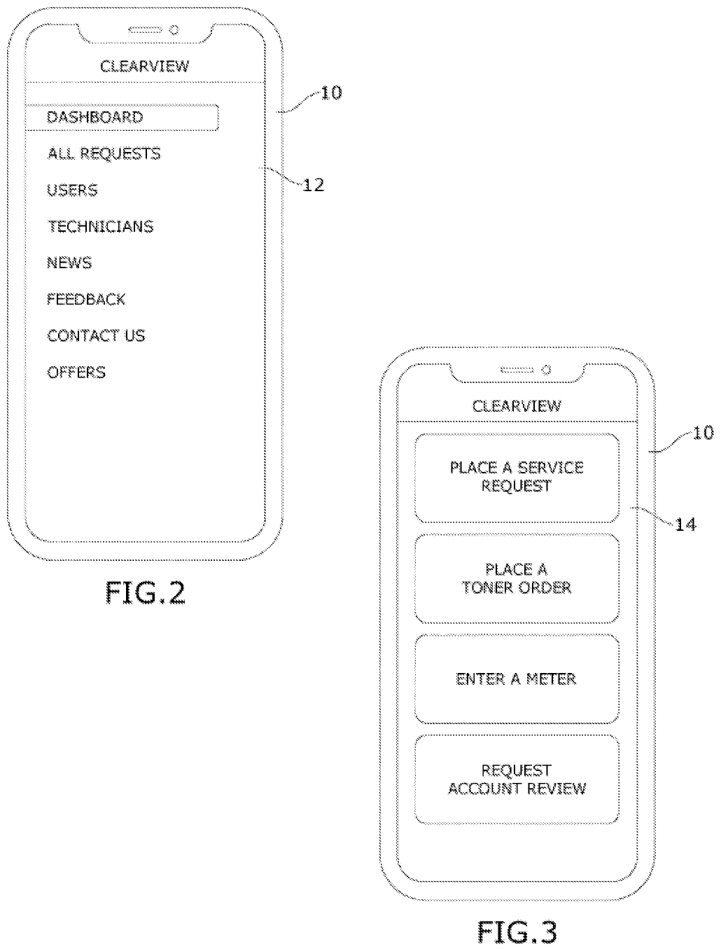

2. By way of a landing page 12 presented via the software application on a user interface of the computing device 10, as illustrated on FIG. 2, the user may create a new user login through inputting user information and logs into the application, wherein the user may define a site location regarding the location where the service is to be provided.

3. The user may select one of a plurality of service requests through a selection page 14 presented by the application via the user interface of the computing device 10, as illustrated in FIG. 3.

4. In certain embodiments, the user may input an applicable error code and/or a brief description of the problem that needs service. Each service request, applicable error code, and/or brief description of the problem/services needed is heretofore referred to as service request data. The service request data may include

5. The application transmits the service request and inputted user data (site location and user information) to the service provider. The user data may include personal information of the user, the service request quote, deadlines, etc. The service request data and associated user data may be retrievably stored in a dispatch database or queue for service. The service provider may use a dashboard to receive and manage the service request.

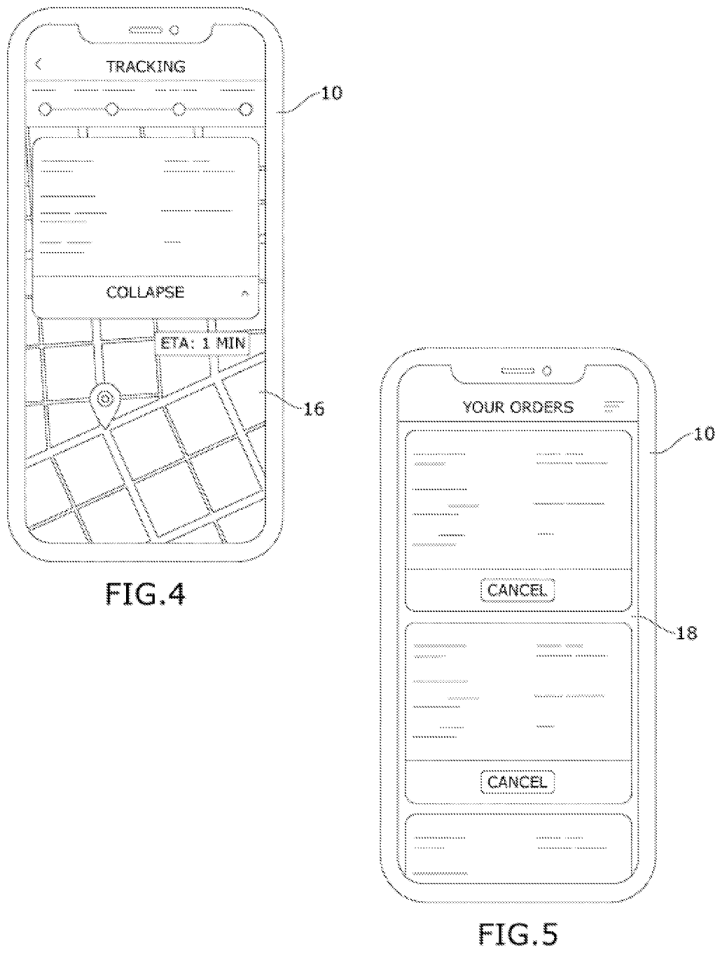

6. The service provider assigns the call to the appropriate technician; the application then notifies the user of receipt of the service request. The user may receive a notification and service request identification number associated with their user data and technician identifying information (TII) of the appropriate technician. The TII may include a real-time GPS location of their technician as they are dispatched and in-route to the site location. The GPS location can be tracked along a map representation 16 provided through a mapping module via the systemic application (previously loaded on a computing device 10), as illustrated in FIG. 4.

7. The application updates the user with the estimated time of arrival, and call details of the appropriate technician. The estimated time of arrival may be calculated by the mapping module using the TII/GPS location and the inputted user data including site location.

8. The user can also use the application to do other things associated with the service request, like place an order for supplies or set deadlines.

9. As the status of the supply order changes, the application updates the user with updated tracking information and updated estimated time of arrival.

10. The user can also use the application to send the service provider data the provider needs to bill or provide a scope of work and quote/re-quote to the customer. For example, the user can send a periodic meter through the application, that the service provider needs. For instance, if a service provider is managing a device or application for the customer, there can sometimes be a meter associated with the output of that device. For example, a meter of black and white prints, or color prints, done on a copier or printer.

11. The user can use the application to request an account review, or for general customer service from the service provider, whereby the software application represents on the user interface of the computing device 10 a review page 18, as illustrated in FIG. 5.

12. The service provider can use the application to send other news and updates to the user that may impact the scope of work.

13. The user can communicate with the service provider in real-time through the application, including selecting a follow up request and/or a change order regarding the service request data.

In an exemplary embodiment, the components of the application, system and method of the present invention may interrelate as follows, and the application and system may be accessed and used by a user in a method comprising one or more of the following steps and combinations thereof. The user may begin by creating a login account (1) and adding user information and may then proceed to perform any of the other functions the application provides (2-12). For instance, a user may select “place a toner order” during steps 3 and/or 4 via the selection page 14. As the order processes, the user may track information with an estimated time of arrival appearing on the map representation 16 for all open service requests.

In an exemplary embodiment, the application, system, and method of the present invention may function and operate in the following manner. The steps of the application may be implemented or work individually as individual steps in completing a service request. Together, the steps may provide the user the ability to place a request for service from anywhere, at any time, from the user mobile device. The application may also provide real time updates to the user.

In an exemplary embodiment, the application, system, and method of the present invention may be made in the following manner. The person would make the invention by using a programming language to program a mobile application that performs these functions of the application described.

In an exemplary embodiment, the application may comprise as necessary components elements of the application which may allow the user to input data pertaining to their account and service request; elements of the application which may send that data to the service provider; and elements of the application which may provide real-time updates from the application to the user (including the geographic location of the technician). In some embodiments, the elements of the application which enable a user to place a supply order, enter a meter, or request an account review may be optional.

In an exemplary embodiment, the application, system, and method may be used in the following manner, the method may comprise one or more of the following steps. When the user needs service from the service provider, the user may use the mobile application to place a request for service. The service request may then be confirmed and dispatched by the service provider. The application may update the user when the call is dispatched, when the technician is in-route, and may provide the current status with notes from the call. In some embodiments, the application of the present invention may be further automated, and capable of providing automatic updates to the user, as determined by the service provider.

An exemplary embodiment of the present invention may provide a mobile service request application, system and method which enables a user who is a customer of a service provider to place a service call, or a request for service from their mobile phone. The user may then receive live updates about the service request, and view a GPS location of an assigned technician when the technician is on the way to the user location to address to the user request. The user may place a request for service directly from the mobile application, and may also receive live, real-time updates as a call is dispatched and resolved. Based on real-time updates, the system or the user may modify the service request or service provider. Service request data may be logged under the user account, where the user may access and view the user service history.

An exemplary embodiment of the present invention may provide a mobile service application, system and method that is a technician specific, and constructed and arranged to provide to a user who is a service technician to communicate with a service provider organization customer relationship management “CRM” software or electronic records program “ERP”, or any other software program in which customer information may be stored. The system is capable of auto-populating the technician mobile app with relevant customer data and technician data.

An exemplary embodiment of the present invention may provide a mobile service application that is a technician specific mobile application, system and method which enables a user who is a technician to communicate with a service provider organization customer relationship management “CRM” software or electronic records program “ERP”, or any other software program in which customer information may be stored. The system is capable of auto-populating the technician mobile app with customer data, such as, for example without limitation, customer contact information, contractual information, service history, or other relevant customer data. The process may occur any time in the technician application, for example without limitation, when the technician “accepts” the service request in the mobile app, or at any other point in the process. The information may also auto-populate in the customer mobile application. Other examples of data capable of being automatically populated by the system may include technician's drive time, average time on site, completed calls for the day, “first call fix” average or “first call efficiency %”, parts usage per call, and any other key performance indicator data which may be defined by the service organization or technician. All of the data would come from the customer relationship management “CRM” software, electronic records management “ERP” program, third party ERP, any other software program, or any other third-party software program wherein customer information may be stored, whether the customer stores the information themselves or a third party stores the information.

The system may include at least one computer with a user interface. The computer may include at least one processing unit coupled to a form of memory. The computer may include, but may not be limited to, a microprocessor, a server, a desktop, laptop, and smart device, such as, a tablet and smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieves technological improvements through the specific processes described more in detail below. In addition, the unconventional and unique aspects of these specific automation processes represent a sharp contrast to merely providing a well-known or routine environment for performing a manual or mental task.

Referring now to the figures of provisional patent applications, incorporated herein by reference in its entirety, the present invention is directed to a mobile service request application, system and method. In accordance with an embodiment of the present invention, a mobile application may enable a customer of a service provider to use a mobile phone to place a service call, or request for service. The user may then request and receive live updates about the service request and see an assigned technician GPS location when the technician is on the way to the user location to fulfill the user service request.

The app, system and method of the present invention solves problems associated with existing service request systems and methods. In prior methods, when a customer service request has been placed, it has been placed by phone or email with live dispatch personnel. A miscommunication of expectations between the customer and the service company may result from this prior method. Further, following a request for service, a delay may occur.

The present invention avoids associated problems by enabling the user to place a request for service using the mobile application of the present invention from the convenience of a mobile telephone or mobile device, at anytime from anywhere. The user may initiate a request for service directly from the mobile application, and request and receive live real-time updates as the service request and service call is dispatched and resolved. The data of the service request and service call may also be also logged under a user account associated with the user, where the user may access and view the user service history.

The mobile application of the present invention allows the user to place a request for service directly from the user mobile phone or mobile device. Once the request has been successfully sent, real time updates may then be provided to the user directly from the application, including request status, estimated time of arrival, real time geographic location of the assigned technician, name and contact information of the assigned technician, and other data relevant to the user account and service request.

The app, system and method of the present invention differs from and distinguishes over what currently exists. There is currently nothing that exists in its field currently. Similar technology is being used for other industries, like hospitality and transportation for example. The app, system and method of the present invention provides an unprecedented improvement over existing service call fulfillment which remedies problems caused by service provider communication and response limited to live phone calls, email, or chat and the consequent delay in updates to the customer, and problems in communication.

In accordance with the app, system and method of the present invention, a user may place a request for service directly from the mobile application, where they will also receive live real-time updates as the call is dispatched and resolved. This data may also be logged under the user account, where the user may access and view the user service history.

In an exemplary embodiment the app and system of the present invention may be accessed and used in a method comprising one or more of the following steps and combinations thereof.

1. If a dispatched technician is detected to be not moving or moving very slowly for a predetermined period, for example because he/she is stuck in traffic, the system is capable of and may dispatch another technician.

2. The system is capable of enabling a service requester to observe the planned route of the technician and direct that the technician travel via a different route.

3. Under a service level agreement between the service provider and the service requester, if the system determines, or if the service requester via his/her mobile device determines, that the technician cannot reach the site of the problem by an agreed time for any reason, another technician may be dispatched or the service requester may be given a refund or credit of some type or discount on supplies.

4. The service requester may be provided an opportunity to choose from several nearby service provider technicians based on service requester's knowledge of the various technicians' present locations and knowledge of current traffic conditions.

5. Service providers and their technicians may be provided the opportunity to enter bids to provide service to the service requester.

6. Technicians may display their skill set specialties in response to a service requester having opened a request. The service requester may view the skill specialties and select the technician he/she wants, and the chosen technician may be dispatched.

An exemplary embodiment of the present invention may provide a mobile service application, system and method that is a technician specific, and constructed and arranged to provide to a user who is a technician and may enable the technician to communicate with a service provider organization customer relationship management “CRM” software or electronic records program “ERP”, or any other software program in which customer information may be stored. All of the data may come from the customer relationship management “CRM” software, electronic records management “ERP” program, third party ERP, any other software program, or any other thirdOparty software program wherein customer information may be stored, whether the customer stores the information themselves or a third party stores the information.

The system is capable of auto-populating the technician mobile app with customer data, such as, for example without limitation, customer contact information, contractual information, service history, or other relevant customer data. The process may occur any time in the technician mobile application, for example without limitation, when the technician “accepts” the service request in the mobile app, or at any other point in the service technician process, the service customer process, or the overall system process. The information may also auto-populate in the customer mobile application or technician mobile application. Other examples of data capable of being automatically populated by the system may include technician's drive time, average time on site, completed calls for the day, “first call fix” average or “first call efficiency %”, parts usage per call, and any other key performance indicator data which may be defined by the service organization or technician. All of the data would come from the customer relationship management “CRM” software, electronic records management “ERP” program, third party ERP, any other software program, or any other third-party software program wherein customer information may be stored, whether the customer stores the information themselves or a third party stores the information.

In a technician specific mobile application that is part of this process, the app may communicate with the service organization's customer database, where customer information is stored. This may be a relationship management software “CRM”, or “ERP” (electronic records program), or any other software program where customer information is stored. =It may then auto-populate into the mobile app the customer's data, including but not limited to their service history, contact information, contractual information, and any other customer data. The process may happen anytime in the technician application, for example when the technician “accepts” the service request in the mobile app, or at any other point in the process. The information may auto-populate in both the technician mobile application and the customer mobile application.

Other nonlimiting examples of data that may populate automatically may include the technician's drive time, average time on site, completed calls for the day, “first call fix” average or “first call efficiency %”, parts usage per call, and other key performance indicator data. All of this data may come from the service organization's database, whether that database is self-managed by the service organization or provided by a third-party. The mobile application may also populate data from a third-party database, third-party customer relationship management software “CRM” or 3rd party “ERP” (electronic records program), or any other third-party software program where customer information is stored, whether they store it themselves, or work with a 3rd party to do so.

In summary, an exemplary embodiment of the present invention may provide a mobile service request application, system and method which enables a user who is a customer of a service provider to place a service call, or a request for service from their mobile phone. The user may then receive live updates about the service request and view a GPS location of an assigned technician when the technician is on the way to the user location to address to the user request. The user may place a request for service directly from the mobile application, and may also receive live, real-time updates as a call is dispatched and resolved. Based on real-time updates, the system or the user may modify the service request or service provider. Service request data may be logged under the user account, where the user may access and view the user service history.

An exemplary embodiment of the present invention may provide a mobile service application, system and method that is a technician specific, and constructed and arranged to provide to a user who is a service technician to communicate with a service provider organization or third-party customer relationship management “CRM” software or electronic records program “ERP”, or any other software program in which customer information may be stored. The system is capable of automatically populating the technician mobile app with relevant customer data and technician data.

In summary, an exemplary embodiment of the present invention may provide a mobile service request application, system and method which enables a user who is a customer of a service provider to place a service call, or a request for service from their mobile phone. The user may then receive live updates about the service request and view a GPS location of an assigned technician when the technician is on the way to the user location to address to the user request. The user may place a request for service directly from the mobile application, and may also receive live, real-time updates as a call is dispatched and resolved. Based on real-time updates, the system or the user may modify the service request or service provider. Service request data may be logged under the user account, where the user may access and view the user service history.

The computer-based data processing system and method described above is for purposes of example only and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer.

It is further contemplated that the present invention may be run on a stand-alone computer system or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

References to a network may include any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks.

Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments the computing systems includes a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments the memory is non-volatile, solid-state memory.

The user interface includes hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the present invention.

It should be understood, of course, that the foregoing relates to exemplary embodiments of the invention and that modifications may be made without departing from the spirit and scope of the invention as set forth in the following claims.

Further embodiments of systems and methods provide a server hosting an Internet web-based application that supports at least one vendor of products. The at least one vendor relies on a network of experienced technicians for field support. Customers of the vendor use customer devices connect to the server and the application to create service requests for problems they are having with the vendor's products. In most cases the customers need onsite service from a technician.

The application provided herein receives the customer request and invokes an algorithm to identify a field technician in the customer's general area to dispatch to the customer's site. The algorithm automatically assigns the best suited technician to handle the service call without interaction or involvement by a website administrator or other person. The algorithm assigns rating to each technician in the customer's service area based on about five parameters and applies weights to the parameters to determine a final rating and hence assignment to the customer's service request.

When a new service call is received by the server, the application will extract information from the customer's inquiry and stored records, feed the information to the algorithm and determine the best technician suited for the service request. Some of the criteria may include current technician workload and distance to customer site. The assigned technician will respond with a message that he/she accepts or declines the the assignment. When accepted, the technician's progress to the site of the customer is monitored by the application executing on the server and by the customer device.

The server, the Internet-based application executing on the server, and the algorithm may provide services described herein to more than one product vendor and may do so under differing service level agreements that may be negotiated. The technicians may be employees of the vendor, may be self-employed contractors, or may be employed by parties unrelated to a party operating the server or the vendor. Customers who use the vendor's products may in some embodiments be employees of the vendors.

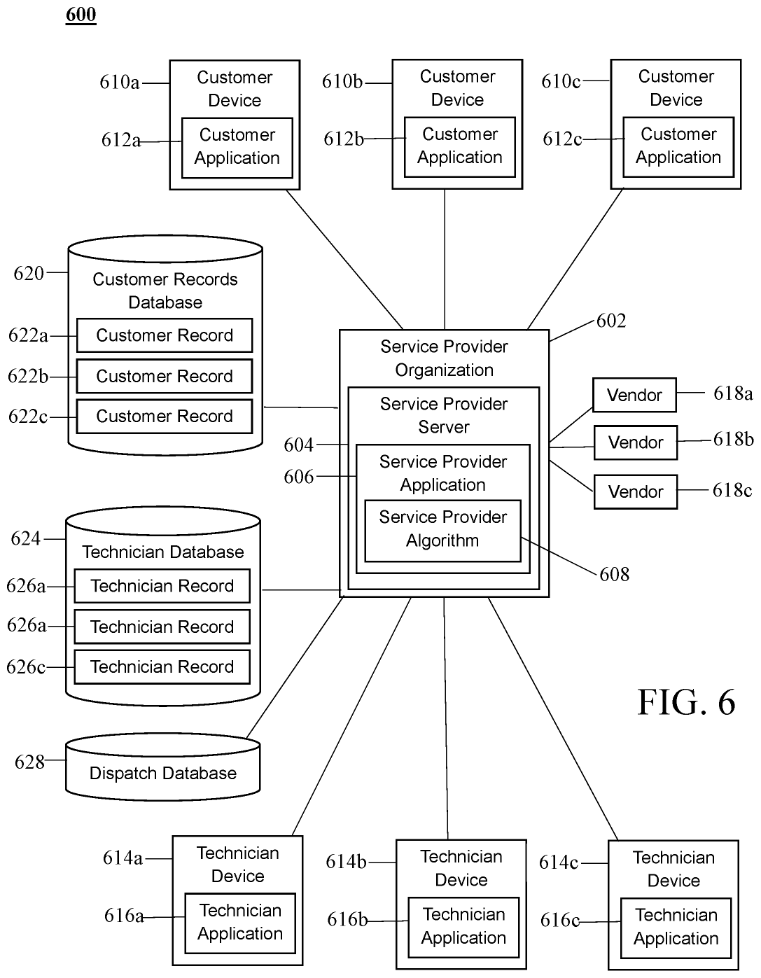

Turning to the figures, FIG. 6 is a block diagram of a system of mobile service request application according to an embodiment of the present disclosure. FIG. 6 depicts components and interactions of a system 600 comprising a service provider organization 602, a service provider server 604, a service provider application 606, and a service provider algorithm 608, referred to hereinafter for brevity as the service provider 602, the server 604, the application 606, and the algorithm 608, respectively.

System 600 also comprises customer devices 610a-c, customer applications 612a-c, technician devices 614a-c, and technician applications 616a-c. The system 600 also comprises vendors 618a-c, a customer records database 620, customer records 622a-c, a technician database 624, technician records 626a-c, and a dispatch database 628.

The service provider organization 602 is an entity that operates the server 604, application 606 and algorithm 608 and makes its services available to vendors 618a-c, their customers, and technicians who service their products. As noted, the service provider 602 may be a unit or department within a vendor 618a-c, may be independent of the vendor 618a-c and hence deal with the vendor 618a-c on an arm's length basis, or may have a different relationship with the vendor 618a-c. Similarly, the service provider 602 may or may not employ technicians using technician devices 614a-c.

The server 604 comprises at least one computer and may comprise a plurality of cloud-based devices and their peripheral devices and networking devices. Hardware comprising the server 604 may be physically situated at more than one geographic location.

The application 606 is an Internet website that may be accessed by devices used by customers to enter and manage service requests and by devices used by field technicians to receive service requests, send messages to the server 602 for forwarding to various parties, and broadcast their present locations and progress. The application 606 oversees the creation and management of service requests to their completion. The application 606 sends messages and directives to technician devices 614a-c about service calls their associated technicians are working on, their performance, and other aspects of their program relationship with the service provider organization 602 that is administering the application 606. As noted above, the central functionality herein provided by the server 604 may be owned and controlled by an entity, for example the service provider 602 that is legally and functionally separate from customers, technicians, and vendors of products and services that the service provider 602 may support under contracts with the vendors including service level agreements.

The application 606 may be a plurality of applications and other software modules executing on various devices including the server 604. The application 606 includes the algorithm 608 which in embodiments comprises more than one algorithm. The algorithm 608 is a central component herein as it handles incoming service requests received from customers, identifies qualified technicians in a service area of the customer, applies criteria to the qualified technicians, makes a determination of the technician best suited to handle a new service request.

Customers needing service on products sold by the vendor 618a-c use customer devices 610a-c that host customer applications 612a-c. The customer devices 610a-c may be mobile devices, for example cellphones or mobile phones, or they may be desktop computers, laptop computers, or tablet computers. The customer application 612a-c is software that executes on the customer devices 610a-c that connects to the server 604 over the world wide web of the Internet or using another network. The customer application 612a-c may be a component of the service provider application 606 such that it is similar to a client portion of a client-server structure. The customer application 612a-c is downloadable from the server 604 or from another source and can be installed on the customer device 610a-c with username and password.

The customer device 610a-c is used by customers to contact the server 604 to open a service request for service on a product sold by the vendor 618a-c. The customer device 610a-c provides the customer's name and location, the product involved, any error messages received, the type of service needed along with timeframe or deadline, and a brief problem description.

The customer device 610a-c receives a service request identification number and identifying information of the technician selected for the service request. The customer uses the customer device 610a-c to track the real-time global positioning system (GPS) location of the technician as the technician travels to the customer's location. This feature is facilitated by a mapping module within the customer application 612a-c.

The customer application 612a-c calculates and updates the customer device 610a-c with dispatch status and with estimated time of arrival of the assigned technician based on GPS information and inputted data provided by the customer. The customer may place orders for supplies associated with the service request via the customer application 612a-c which provides updates on status of orders and updated tracking information for estimated time of arrival of the ordered supplies.

The customer application 612a-c allows the customer to send to the server 604 or other device necessary data for billing purposes or for providing a scope of work. The customer application 612a-c enables the customer to request an account review or seek general customer service from the service provider 602. The customer application 612a-c provides a review page for this purpose. The customer application 612a-c facilitates real time communication between the customer device 610a-c and the service provider 602. The customer may request follow-ups or change orders regarding their service request data. The customer may modify service requests or even change the service provider 602 in some embodiments.

The customer application 612a-c allows the customer to track all orders they have placed and filter out some results. The customer application 612a-c enables the customer to generate a “contact us” request for a website administrator associated with the server 604. The customer application 612a-c further enables the customer to chat directly with website administrators and have direct interaction with assigned technicians as well.

Technician devices 614a-c are used by field technicians to handle service requests and other tasks. The technician application 616a-c executes on the technician devices 614a-c. Similar to the customer application 612a-c, the technician application 616a-c is a component of the service provider application 606 executing on the server 604. The technician device 614a-c receives service requests from the application 606 and allows technicians to communicate with the service provider 602 or third-party customer relationship management (CRM) software, electronic records program (ERP), or other software programs where customer information is stored and where technicians have been given permissions.

The technician application 616a-c automatically populates customer information including customer contact information, contractual details, and service history. This data may be received from the customer records database 620, from customer relationship management (CRM) software or electronic records program (ERP), or from other third-party software programs storing customer information.

The technician application 616a-c also automatically populates technician data such as drive time, average time on site, completed calls for the day or other time period, “first call fix” average, parts usage per call, and other performance indicator data. This information may be retrieved from databases of the service provider 602 or from third-party sources.

Technicians can accept or reject assigned service requests and they can update their real time status. Technicians can chat directly with web administrators and can submit feedback on completed requests. The technician application 616a-c provides a feature to navigate to customer locations using a built-in mapping feature or by accessing map applications provided by third parties.

Website administrators who oversee the service provider application 606 may have a single dashboard to check service requests, assign or reassign technicians to service calls and manage orders of products. Website administrators can generate offers and news announcements for customer from their dashboard.

Website administrators have the option to disable portions of the application 606 and manually control certain functions thereof. They can enable or disable parameters of the algorithm 608 that automatically assigns technicians to service requests. Website administrators can communicate directly with customers and technicians and handle account review requests or training requests as well as handle toner orders and meter requests under some programs.

Website administrators further handle content management, user activity logging, and user feedback collection. Encryption of data for enhanced security is also available. Push notifications may be done wherein website administrators have the ability to send push notifications to technician devices 614a-c and customer devices 610a-c.

The algorithm 608, which may be referred to as an auto assign algorithm, is used to evaluate service requests, evaluate available technicians, and determine a technician to assign to a given service request. The algorithm 608 assigns a rating to each available technician based on a group of parameters, for example five parameters, and sorts the technicians based on ratings on each service call. When a new service call is received from a customer device 610a-c, the algorithm 608 extracts required information from the call and assigns the created service request to the highest rated technician for that call. As noted, website administrators have the authority to change technicians from their dashboards.

The algorithm 608 rates technicians on a group of parameters. In an example five parameters may be used. A first parameter may be location wherein technicians' distances to the customer's site is measured. A second parameter may be current call queue such that the number of calls technicians are working on is considered. A third parameter examines availability to determine whether the technician is online or offline.

A fourth parameter examines time to customer location, a parameter that considers which technician can reach the customer location in the minimum amount of time. The fifth parameter checks how many certificates have been assigned to each technician receiving consideration. The algorithm rates each technician on these parameters by determining an average rating and applies weights to the parameters, in embodiments equal weights and in other embodiments unequal weights. Website administrators have the authority to enable and disable any of these parameters from their dashboards such that the overall score may change based on administrator action.

Website administrators may also dispatch sales demonstration calls with real time tracking of sales specialists. Such dispatching may require thorough market research to ensure availability of products with functionalities needed for the particular sales prospecting situation.

The customer records database 620 stores customer records 622a-c including customer identifying information, their contract and account status, previous service requests. The technician database 624 stores technician records 626a-c including identifying information, technical competencies and certifications, and customer ratings. The dispatch database 628 stores information about current on ongoing service requests and closed service requests.

In an embodiment, a system of a mobile service request application and algorithm is provided comprising a computer and an application comprising an algorithm. The system receives a service request from a customer device, the request comprising at least a location of a service need. The system also determines a service area associated with the location. The system also identifies locations of technician devices associated with technicians presently located in the service area, the technicians identified as qualified to address the service need. The system also ranks the technicians by parameters comprising:
a) distance of the technician devices to the location of the service need,
b) technician queue size by quantity of pending service calls,
c) status of technician comprising one of online and offline,
d) estimated time to reach the location of service need, and
e) number of certificates associated with each technician in the service area,

The system also assigns weights to each parameter for each technician. Based on at least on the assigned weights, the system also generates a final ranking for the technicians. Based at least on the ranking, the system also dispatches a first technician to the location of service need.

The received service request from the customer device further comprises customer identifying information, applicable error code, description of problem, and services needed. The algorithm processes each step leading to generation of the final ranking without intervention by an administrator of the system.

Portions of the algorithm may be disabled and replaced by administrator intervention, the intervention comprising at least manually changing the first technician to a second technician. Technician devices and customer devices access the application and algorithm using separate client portions of the application.

Dispatched technicians are provided options to decline a dispatching. The application enables direct chatting by the customer device with website administrators of a service provider associated with the computer, application, and algorithm, and further enables direct interaction by the customer device with technician devices.

The system accepts feedback from technician devices about completed requests. Administrators of the system communicate directly with customer devices and technician devices from a backend of the system.

In another embodiment, a system of handling service requests at field locations is provided. The system comprises a technician device and a technician portion of a mobile application that accesses an application and algorithm executing on a remote server hosting an Internet website. The system also reports location of the device and availability of an associated technician to the remote server. The system also receives assignment of a service call at a remote location requiring travel. The system also one of accepts and declines the assignment.

The device accesses applications and algorithms executing on remote servers for a plurality of product and service vendors, wherein the technician is qualified to provide field service for the vendors' products and services. The device accesses CRM and ERP sources to access certain information about customers associated with service calls.

The device auto populates technician data comprising at least one of drive time, average time on site, completed calls for a given day, first call fix average, and parts usage per call. The device auto populates customer data comprising customer contact information, contractual details, and service history.

In yet another embodiment, a method for requesting onsite service is provided. The method comprises a customer device initiating a service request to a remote server hosting a website associated with a service provider for onsite service. The method also comprises the device including identifying information, location, applicable error code, description of problem, and services needed in the service request. The method also comprises the device receiving notification of a service request identification number and identifying information of a technician dispatched to the location, the technician associated with the service provider.

The method also comprises the device initiating the service request via a downloadable application executing on the device. The method also comprises the device tracking via global positioning system (GPS) movement of the first technician as the first technician travels to the location.

The method also comprises the device accessing multiple service providers for onsite service. Each of the multiple service providers is associated with a different manufacturer of goods. The method also comprises the device communicating on a real time basis with website administrators of the service provider.

What is claimed is:

1. A system of a mobile service request application and algorithm, comprising:
a computer, and
an application comprising an algorithm that:
receives a service request from a customer device, the request comprising at least a location of a service need,
determines a service area associated with the location,
identifies locations of technician devices associated with technicians presently located in the service area, the technicians identified as qualified to address the service need,
ranks the technicians by parameters comprising:
a) distance of the technician devices to the location of the service need,
b) technician queue size by quantity of pending service calls,
c) status of technician comprising one of online and offline,
d) estimated time to reach the location of service need, and
e) number of certificates associated with each technician in the service area,
assigns weights to each parameter for each technician,
based at least on the assigned weights, generates a final ranking for the technicians, and
based at least on the ranking, dispatches a first technician to the location of service need.

2. The system of claim 1, wherein the received service request from the customer device further comprises customer identifying information, applicable error code, description of problem, and services needed.

3. The system of claim 1, wherein the algorithm processes each step leading to generation of the final ranking without intervention by an administrator of the system.

4. The system of claim 1, wherein portions of the algorithm may be disabled and replaced by administrator intervention, the intervention comprising at least manually changing the first technician to a second technician.

5. The system of claim 1, wherein technician devices and customer devices access the application and algorithm using separate client portions of the application.

6. The system of claim 1, wherein dispatched technicians are provided options to decline a dispatching.

7. The system of claim 1, wherein the application enables direct chatting by the customer device with website administrators of a service provider associated with the computer, application, and algorithm, and further enables direct interaction by the customer device with technician devices.

8. The system of claim 1, wherein the system accepts feedback from technician devices about completed requests.

9. The system of claim 1, wherein administrators of the system communicate directly with customer devices and technician devices from a backend of the system.

10. A system of handling service requests at field locations, comprising:
a technician device; and
a technician portion of a mobile application that:
accesses an application and algorithm executing on a remote server hosting an Internet website,
reports location of the device and availability of an associated technician to the remote server,
receives assignment of a service call at a remote location requiring travel, and
one of accepts and declines the assignment.

11. The system of claim 10, wherein the device accesses applications and algorithms executing on remote servers for a plurality of product and service vendors, wherein the technician is qualified to provide field service for the vendors' products and services.

12. The system of claim 10, wherein the device accesses CRM and ERP sources to access certain information about customers associated with service calls.

13. The system of claim 10, wherein the device auto populates technician data comprising at least one of drive time, average time on site, completed calls for a given day, first call fix average, and parts usage per call.

14. The system of claim 10, wherein the device auto populates customer data comprising customer contact information, contractual details, and service history.

15. A method for requesting onsite service, comprising:
a customer device initiating a service request to a remote server hosting a website associated with a service provider, the service request seeking onsite service;
the device including identifying information, location, applicable error code, description of problem, and services needed in the service request; and
the device receiving notification of a service request identification number and identifying information of a technician dispatched to the location, the technician associated with the service provider.

16. The method of claim 15, further comprising the device initiating the service request via a downloadable application executing on the device.

17. The method of claim 15, further comprising the device tracking via global positioning system (GPS) movement of the first technician as the first technician travels to the location.

18. The method of claim 15, further comprising the device accessing multiple service providers for onsite service.

19. The method of claim 18, wherein each of the multiple service providers is associated with a different manufacturer of goods.

20. The method of claim 15, further comprising the device communicating on a real time basis with website administrators of the service provider.
